(19) United States
(12) Patent Application Publication
(10) Pub. No.: US 2024/0353053 A1
(43) Pub. Date: Oct. 24, 2024

(54) RETRACTOR ARRANGED FOR TOP MOUNTING

(71) Applicant: HAMMERHEAD INDUSTRIES, INC., VENTURA, CA (US)

(72) Inventors: JOHN A. SALENTINE, GOLETA, CA (US); KENNETH S. COLLIN, JR., OJAI, CA (US)

(21) Appl. No.: 18/601,858

(22) Filed: Mar. 11, 2024

Related U.S. Application Data
(60) Provisional application No. 63/451,518, filed on Mar. 10, 2023.
(60) Provisional application No. 63/464,452, filed on May 5, 2023.

(51) Int. Cl. F16M 13/00; F16M 13/04

(52) U.S. Cl. CPC F16M 13/005; F16M 13/04

(57) ABSTRACT

A retractor system for personal articles comprising a retractor having a mounting mechanism for mounting to a user, with the retractor comprising a housing with a top surface, an internal spring, and an extendable line capable of extending from the housing through the retractor top surface. The internal spring urges retraction of the extendable line back in the retractor housing. An adaptor can be included that is integral to or mounted to a personal article, with the adaptor having an extension portion extending away from the personal article. The extendable line is attached to the adaptor or personal article such that when the line is retracted into the retractor, the extension portion is on the retractor's top surface. The retractor system can also comprise one or more magnets that provide a magnetic attraction between the personal article and the retractor to securely hold the personal article to the retractor. Some of these magnets can comprise anti-swing mechanisms included to prevent swinging of the personal article when it is not in use.

This application claims the benefit of U.S. Provisional Patent Appl. Ser. No. 63/451,518, filed on Mar. 10, 2023, and U.S. Provisional Patent Appl. Ser. No. 63/464,452, filed on May 5, 2023.

### BACKGROUND OF THE INVENTION

### Field of the Invention

This invention relates to retractors, and in particular, retractor systems having a retractor device arranged to securely hold a personal device to the top of the retractor.

### Description of the Related Art

Retracting devices have been developed for housing cables and cords such as those used for telephones, hose reels and cellular phone earpieces. [See U.S. Pat. No. 5,094,396 to Burke, U.S. Pat. No. 5,507,446 to Ditzig and U.S. Pat. No. 4,946,010 to DiBono.] Retracting devices have also been developed having a means for removing the tethered article from the tethering device such as in the case of keys, SCUBA gear and microphones.

A wrist lanyard has been developed which helps prevent personal devices such as cell phones from falling to the ground when being used. The lanyard typically comprises a rope or string that is tied or otherwise attached to the cell phone and has a loop that is large enough for a user's hand to pass through. To secure the cell phone, the user must pass a hand through the loop when the cell phone is in the user's hand. When the cell phone is not in use, the lanyard can be tied to a belt loop. One disadvantage of this device is that when the phone is tied to a belt loop, untying the lanyard from the loop to use the phone can be awkward and inconvenient. It can also be awkward passing a hand through the loop every time the cell phone is used.

More recent arrangements have provided for tethering of the phone or other personal article to a retractor, that is then mounted to the user's body. Some of these arrangements are described in U.S. Pat. Nos. 7,665,684 and 8,794,560, both to Salentine et al., the contents of which are incorporated herein by reference. Some of these recent arrangements also provide for attaching one or more retractor devices to a garment and attaching a personal article to the retractor where it is available for easy access. In some of these arrangements, the retractor devices can be arranged in a pocket so that the line pulls the personal article back toward and into the pocket. These retractor arrangements can be included as part of or as add-ons to a garment, and are particularly applicable for the users mentioned above. Some of these retractor arrangements are described in U.S. patent Ser. Nos. 10/299,572, 11/103,052 and 11/812,844, all to Salentine et al., the contents of which are incorporated herein by reference.

Different products have been developed to secure a cell phone to a user, with one being sold by Hammerhead, Inc. under the Smart Phone Keeper™ trade name. In this arrangement, a retractor is mounted to the user such as to a belt using a belt clip or to the desired location on the user by, for example, a mounting pin. A first connector portion is attached to the retractor's extendable line. A tether or lanyard is also provided with a mounting pad at one end for adhering to a cell phone or its case, and a second connector portion is provided at the second end of the lanyard for mating with the first connector portion to connect the lanyard to the retractable line. This connects the cell phone to the retractor so that when the cell phone is in use, the extendable line is extended from the retractor against the retraction force of the retractor's internal spring. When the phone is not in use, the line is retracted into the retractor to hold the phone at the retractor and to prevent from falling.

In these arrangements, when the cell phone or personal article is not used it can hang in front of the user, either below the retractor device mounted to the user or outside of the user's pocket. One disadvantage of this arrangement is that when the personal article is not grasped by the user, it can swing back and forth below the retractor or outside of the pocket. This can be uncomfortable for the user, and can result in damage to the personal article, in damage to surrounding articles, and in extreme cases can result in injury to the user or those around the user.

### SUMMARY OF THE INVENTION

The present invention is generally directed to a retractor system for personal articles such as a cell phone that allows for easy mounting to a user, while still allowing for easy and reliable coupling of the personal article to the retractor when the personal article is not in use. One embodiment of a retractor system according to the present invention comprises a retractor having a mounting mechanism for mounting to a user. The retractor comprising a housing with a top surface, an internal spring, and an extendable line capable of extending from said housing through the retractor top surface. The internal spring urges retraction of the extendable line back in the retractor housing. An adaptor can be included that is integral to or mounted to a personal article, with the adaptor having an extension portion extending away from the personal article. The extendable line is attached to the adaptor or personal article such that when the line is retracted into the retractor, the extension portion is on the retractor's top surface.

Different embodiments of the invention can also comprise one or more magnets that provide a magnetic attraction between the personal article and the retractor to securely hold the personal article to the retractor. Some of these magnets can comprise anti-swing mechanisms included to prevent swinging of the personal article when it is not in use.

The systems according to the present invention can comprise many different features as described below. These and other aspects and advantages of the invention will become apparent from the following detailed description and the accompanying drawings which illustrate by way of example the features of the invention.

### BRIEF DESCRIPTION OF THE DRAWINGS

FIG. 1 is a perspective view of one embodiment of a retractor and personal article system according to the present invention;

FIG. 2 is a perspective view of the system shown in FIG. 1, with the personal article separated from the retractor;

FIG. 3 is a perspective view of another embodiment of a retractor system with personal article adaptor according to the present invention;

FIG. 4 is a side perspective view of the system shown in FIG. 3, with the personal article adaptor separated from the retractor;

FIG. 5 is a back perspective view of the system shown in FIG. 3, with the personal article adaptor separated from the retractor;

FIG. 6 is a perspective view of another embodiment of a retractor system according to the present invention with the personal article comprising a spray device;

FIG. 7 is a perspective view of the retractor system of FIG. 6, with the personal article separated from the retractor;

FIG. 8 is a perspective view of another embodiment of a retractor system according to the present invention with the personal article comprising a flashlight; and

FIG. 9 is a perspective view of the retractor system of FIG. 8, with the personal article separated from the retractor.

### DETAILED DESCRIPTION OF THE INVENTION

The present invention is directed to different retractor and personal article systems used to mount personal articles mounted to a user, such as to the user's garments. In some embodiments, the systems can comprise a retractor mounted to a user. The retractor can be mounted in different ways with some embodiments having retractors mounted to a garment or in the pocket of a garment, such as by a mounting pin. In some embodiments, the retractor can include a clip for mounting to the belt of a user. The present invention is particularly applicable to garments worn by the users mentioned above, including first responders, construction workers, military personal or sportsmen.

The retractors also include a connection mechanism for mounting a personal article to the retractor's extendable line. Many different attachment mechanisms can be used as further described below. In some embodiments, an adaptor can be provided that is connected to the retractor's extendable line, with the adaptor also mounted to the personal article. The retractor can be mounted to the user with the retractor housing opening for the extendable line directed up. When the personal article is being used, the line can also extend up from the retractor as the personal article is separated from the retractor. When the personal article is no longer being used, the extendable line can retract into the retractor under the force of an internal spring as the personal article moves back to the retractor.

The adaptor can comprise a tab or extension portion that extends away from the personal article and rests on top of the retractor. The extendable line can be connected to the tab, and in some embodiments, the tab can have a first magnet. In some embodiments, the top of the retractor can have a second magnet that cooperates with the tab's first magnet to provide a magnetic force therebetween to hold the personal article to the retractor when the personal article is not in use. In other embodiments, the retractor can have metallic components such that the first magnet is attracted to the retractor's metallic components to hold the two together. In these embodiments, a second magnet may not be needed. Additional magnets can be included to hold the personal article in place without swinging.

It is understood that this is just one of the many different arrangements that can be used to connect the personal article to the retractor and to use magnetic force to reliably hold the personal article to the retractor when the personal article is not in use. This can include different adaptors having different shapes and sizes that are mounted to the personal article in different ways. In other embodiments different lock and magnet combinations can be used, with these being only a few of the different mounting arrangements.

In still other embodiments, magnets need not be included to hold the personal article to the retractor. In these embodiments, the force of gravity in combination with of holding force of the extendable line is strong enough to securely hold the personal article to the top surface of the retractor.

Other embodiments can comprise different features such as anti-wing magnets arranged in different ways to prevent swinging of the personal article in relation to the retractor. Still other embodiments can comprise different types of connectors to allow for connection of the personal article to the extendable line, and features such as lanyards can be included between the extendable line and the personal article.

The present invention is described herein with reference to certain embodiments, but it is understood that the invention can be embodied in many different forms and should not be construed as limited to the embodiments set forth herein. It is further understood that different embodiments can comprise different materials arranged in different ways, and can comprise different features. Different embodiments can also be arranged for mounting to other locations other than directly to a user.

It will be understood that when an element is referred to as being “on” or “connected to” another element, it can be directly on, or in contact with the other element or intervening elements may be present. In contrast, when an element is referred to as being “directly on”, or “directly connected to” another element, there are no intervening elements present. Although the terms first, second, etc. may be used herein to describe various elements, and/or sections, these elements and/or sections should not be limited by these terms. These terms are only used to distinguish one element, or section from another element, or section. Thus, a first element or section discussed herein could be termed a second element, or section without departing from the teachings of the present invention.

Embodiments of the invention are described herein with reference to perspective view illustrations that are schematic illustrations of an embodiment of the invention. As such, the actual thickness or size of components can be different, and variations from the shapes of the illustrations as a result, for example, of manufacturing techniques and/or tolerances are expected. Embodiments of the invention should not be construed as limited to the particular shapes as illustrated herein but are to include deviations in shapes that result, for example, from manufacturing. A region or element illustrated or described as being generally square or rectangular can have rounded or curved features due to normal manufacturing tolerances. Thus, the features illustrated in the figures are schematic in nature and their shapes are not intended to illustrate the precise shape of a feature of a device and are not intended to limit the scope of the invention.

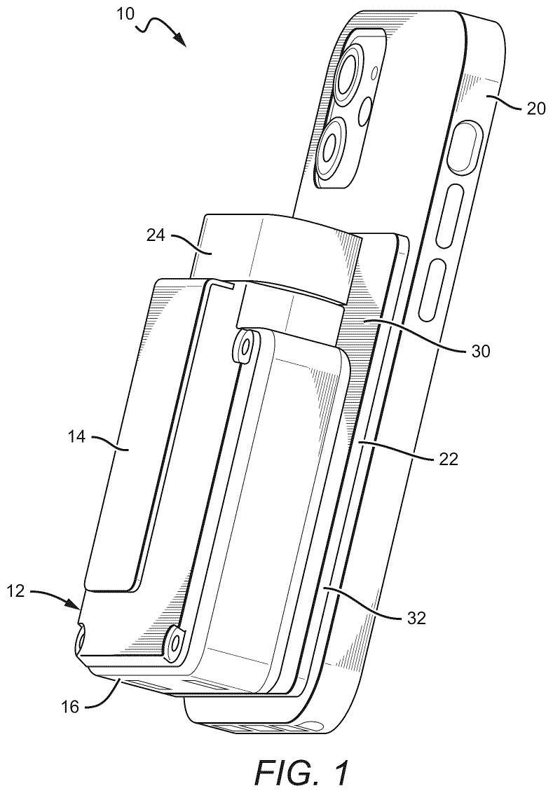

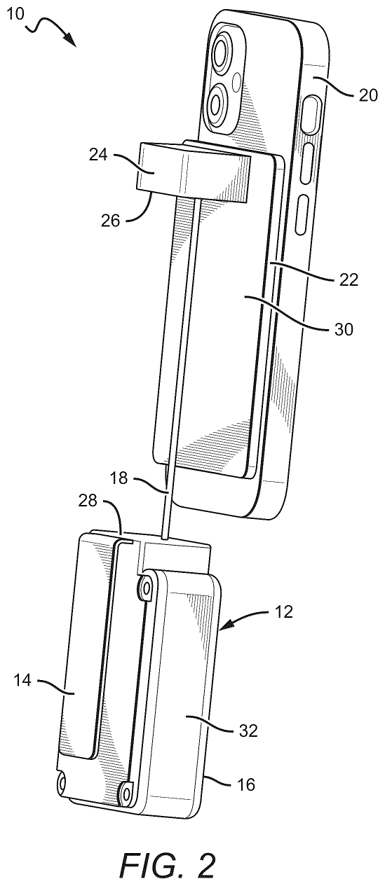

FIGS. 1 through 2 show one embodiment of a retractor and personal article system 10 according to the present invention that comprises a retractor 12 having a mounting device 14 for mounting to a user. The mounting device 14 can comprise many different mechanisms for mounting to the user in many different ways and in many different locations. In the embodiment shown, the mounting mechanism comprises a clip for mounting to the user's belt, waistline, or pocket.

In the embodiment shown, the retractor 12 comprises a retractor housing 16 with an extendable line 18 (shown in FIG. 2) that is coiled and housed within the retractor housing 16. The extendable line extends from the retractor housing against the force of an internal spring (not shown) that urges retraction of the extendable line.

A personal article 20 is attached to the line 18 and the line 18 can extend from the retractor housing 16 under a pulling force when the user uses the personal article 20. In the embodiment shown, the personal article is a cell phone, but it is understood that many other personal articles can be used. When the user's pulling force is removed from the personal article 20, the line 18 can be pulled back into the housing 16 and recoiled by the internal coil spring. This in turn pulls the personal article 20 back toward the retractor mechanism 12 until the personal article 20 abuts the retractor housing 16.

The personal article 20 can be attached to the line 18 using many different attachment mechanisms. In the embodiment shown, an adaptor 22 is included that is mounted to the back of the personal article 20. The adaptor 22 can be mounted to the personal article 20 using many different methods and mechanism. In some embodiments, an adhesive can be used, while in other embodiments tape, Velcro®, screws or brackets can be used. In still other embodiments, the adaptor 22 can me molded as part of the personal article housing.

In the embodiment shown, the adaptor comprises a tab 24 that extends away from the personal article 20, with the line 18 attached to the tab 24. When the line 18 is retracted into the retractor housing 16, the tab's bottom surface 26 rests on the retractor housing 16 upper surface 28 with FIG. 1 showing the fully retracted position of the system 10.

In some embodiments, the tab 24 can comprise one or more first magnets, with the magnetic force of the first magnets extending out of the tab's bottom surface 26. The retractor housing 16 can have one or more second magnets with the magnetic force extending out the housing upper surface 28. In some embodiments the one or more second magnets can be mounted at or near the upper surface 28. As the extendable line is retracted into the retractor and the personal article 20 is moved toward the retractor 12 the magnetic force from the tab's bottom surface 26 and the housing's upper surface cooperate to draw the tab 24 to the retractor 12. When fully retracted, the tab 24 rests on the housing upper surface 28, with gravity and the magnetic force holding the personal article 20 to the retractor 12.

When the user uses the personal article 20, the user provides a pulling force to the personal article 20 sufficient to overcome the magnetic force and to separate the personal article 20 from the retractor 12 while also extending the line 18. When the user releases the pulling force, the line retracts and pulls the personal article 20 to the retractor 12, where the tab 24 resting on and held firmly at the top surface of the retractor 12.

In the embodiment shown, the adaptor comprises a tab 24 that extends away from the personal article 20, with the line 18 attached to the tab 24. When the line 18 is retracted into the retractor housing 16, the tab's bottom surface 26 rests on the retractor housing's upper surface 28 with FIG. 1 showing the fully retracted position of the system 10.

A personal article 20 is attached to the line 18 and the line 18 can extend from the retractor housing 16 under a pulling force when the user uses the personal article 20. In the embodiment shown, the personal article is a cell phone, but it is understood that many other personal articles can be used. When the user's pulling force is removed from the personal article 20, the line 18 can be pulled back into the housing 16 and recoiled by the internal coil spring. This in turn pulls the personal article 20 back toward the retractor mechanism 12 until the personal article 20 abuts the retractor housing 16.

It is understood that in other embodiments according to the present invention different numbers of magnets can be used. In some embodiments the retractor can be made of metallic components that are drawn to the magnets, such as the retractor housing 16 being at least partially made of a metallic material. In these embodiments, one or more magnets may only be needed in the tab 24. Similarly, the tab 24 or other parts of the adaptor 22 can be made of metallic material such that one or more magnets are only required on the retractor 12. The magnetic attraction between the magnets and the metallic portions is sufficient to hold the tab to the retractor housing.

In still other embodiments, additional magnets can be included in different locations to provide additional holding force. In one embodiment the tab's planar surface 30 and first retractor side surface 32 can each have magnets that cooperate to hold the planar surface 30 to the side surface 32. This can provide an additional holding force that can prevent swinging of the personal article 20 when the user moves about. Like above, if the planar surface 30 or side surface 32 are made at least partially of a metallic material, then each surface may not need to include a magnet to provide the desired magnetic holding force. For example, if the side surface 32 was made at least partially of a metallic material that a magnet may only be needed on the plana surface 30.

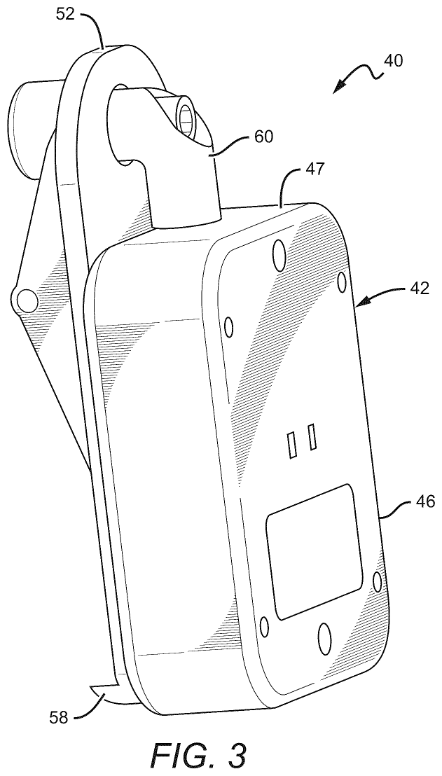

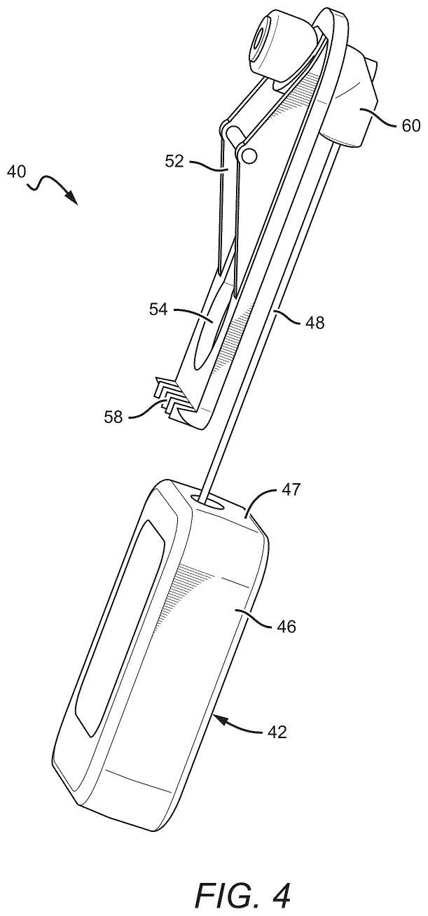

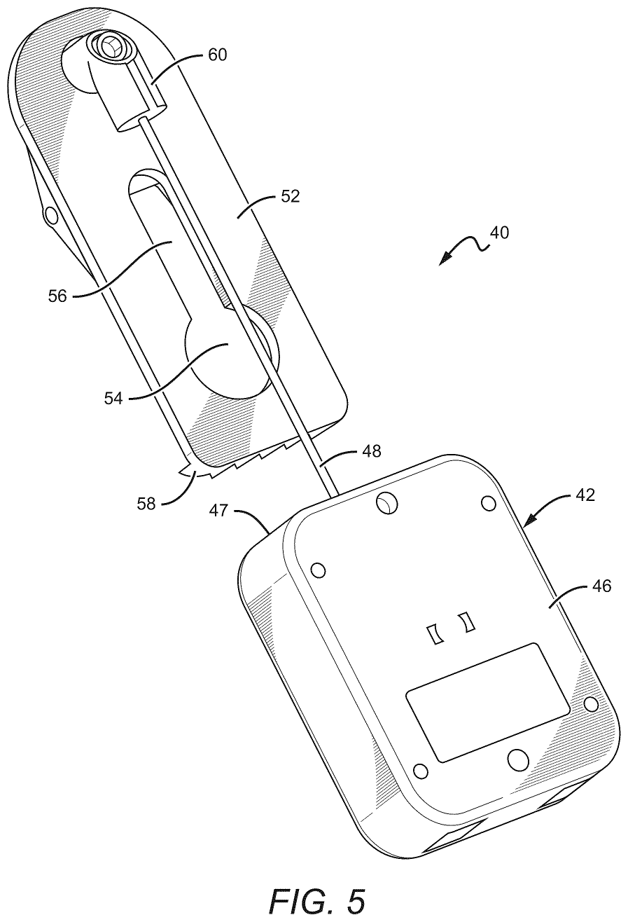

FIGS. 3 through 5 show another embodiment of a retractor and personal article system 40 according to the present invention that comprises a retractor 42 having a mounting device (not shown) for mounting to a user. The mounting device can comprise many different mechanisms for mounting to the user in many different ways and in many different locations, such as those described above. In the embodiment shown, the mounting mechanism comprises a clip for mounting the user's belt, waistline, or pocket. The retractor 42 comprises a retractor housing 46 with an extendable line 48 (shown in FIGS. 4 and 5) that is coiled and housed within the retractor housing 46. The extendable line 48 extends from the retractor housing against the force of an internal spring (not shown) that urges retraction of the extendable line.

Like the embodiment above, in the system 40 an adaptor 52 is included that can be mounted to a personal article (not shown) using many different methods and mechanisms mentioned above. In the embodiment shown, the adaptor 52 is particularly arranged for use with a radio mic, such as those used by first responders, but it is understood that the different adaptors can be used with other personal articles such as cell phones. The adapter 52 is arranged with an opening 54 and slot 56, with the opening sized so that the button from the mic can pass through. The mic button can be raised on the back of the mic by a post, and the post can then slide up and to the top of the slot 56 with the bottom surface of the mic resting on the tabs 58. This arrangement holds the mic to the adaptor 52 during use and when resting on the retractor.

The adaptor 52 comprises a support 60 that in the embodiment shown is a right-angled cylindrical shaped, but can be arranged in many ways in different embodiments. In some embodiments it can have a shape similar to the tab described above. The support 60 is affixed at one end to the back surface of the adaptor 52, or the support 60 is formed integral to the adaptor 52. The extendable line 48 is connected to the other end of the support 60. When the line 48 is retracted as shown in FIG. 3, the end of the support 60 with the line rests on the top surface 47 of the retractor 42 at the opening for the line 48. The support 60 provides for a set-off for the adaptor 52 so that the adaptor 52 rests against the front surface of the adaptor 42 as shown in FIG. 3.

When the personal article (i.e. mic) is in use, the adaptor 52 is pulled away from the retractor 42 and the line 48 is extended from the retractor 42 as shown in FIGS. 4 and 5. When the personal article is done being used, the pulling force can be released and the adaptor 52 can return to its position on the retractor 42 as shown in FIG. 3. In the embodiment shown, the retraction force from the internal spring provides a sufficient pulling on the line 48 and the adaptor 52 to hold adaptor 52 to the retractor as shown without the use of additional holding mechanisms such as magnets. It is understood that magnets can be included as described above, such as on the support 60 or the retractor 42 or both. It is also understood that other holding features can be included, such as Velcro®, that can hold the adaptor 52 to the retractor 42. Other features can be also included in the system 40 such as anti-swing magnets. In some embodiments these anti-swing magnets can be included on one or more surfaces of the adaptor 52, or on one or more surfaces of the retractor, or both.

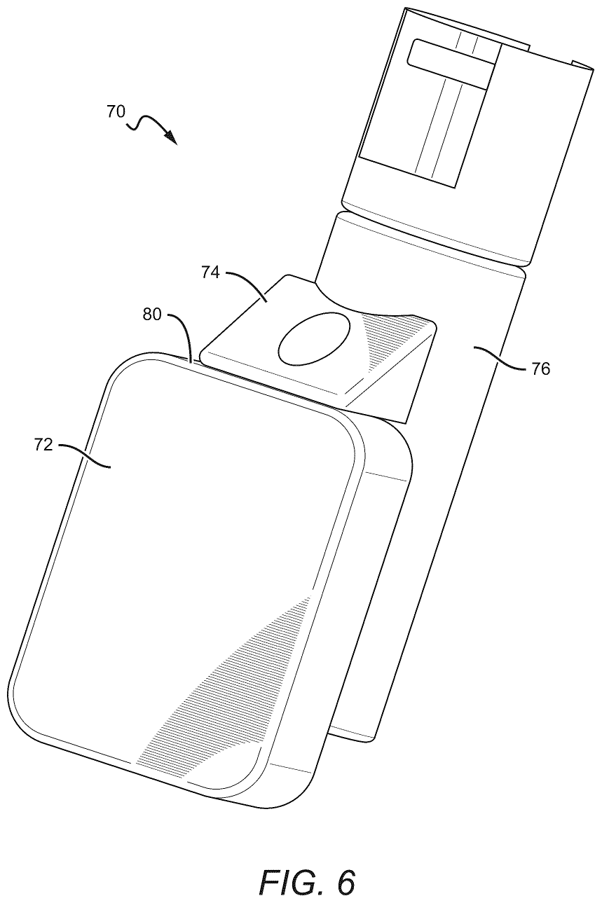

FIG. 6 shows another embodiment of retractor system 70 comprising a retractor 72 and an extension portion 74 mounted to or integral to a personal article 76. In this embodiment, the personal article 76 comprises a spray device such as personal defense pepper spray device. The extension portion 74 can be mounted to or formed integral to the pepper spray device body. The extension portion 74 can be mounted using many different methods, materials and devices such as different adhesives, tapes, zip-ties, brackets, clips, Velcro®, straps or bands. In other embodiments, the adaptor can be part of an adaptor that the spray bottle is mounted in or to, such as a cylindrical adaptor sized for the spray bottle or an adapter similar to the ones described in the embodiments above.

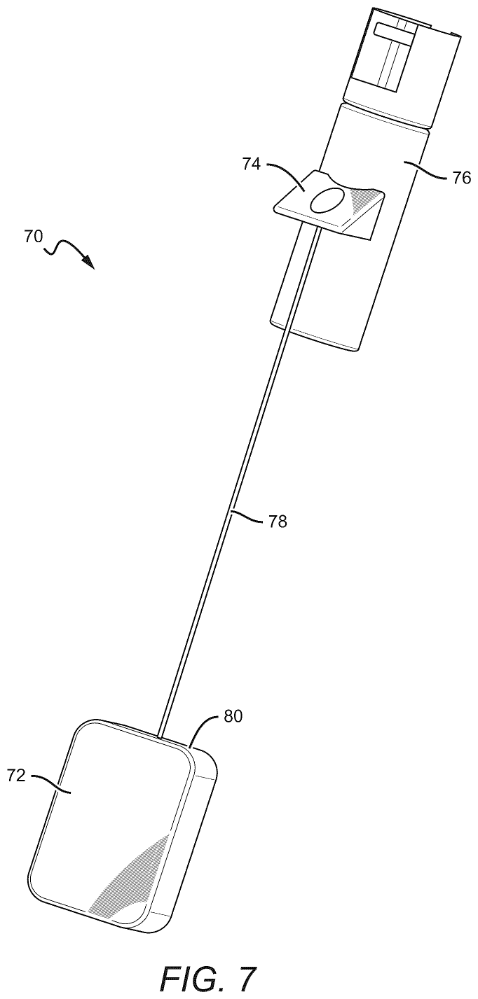

FIG. 7 shows a perspective view of the retractor system 70, with the personal article 76 separated from the retractor 72. Like the embodiments above, this separation causes the extendable line 78 to extend from the retractor housing at the top surface 80, against the force of the retractor's internal spring (not shown). When the separation force is removed, the internal spring retracts the extendable line 78 back into the retractor and the extension portion 74 rests on the top surface 80 under the pulling force of the extension line. In some embodiments, this pulling force is sufficient to securely hold the personal article 76 to the retractor through normal activities of the user. In other embodiments, the extension 74, personal article 76, and/or the retractor can include magnets to provide a greater holding force between the personal article 76 and the retractor.

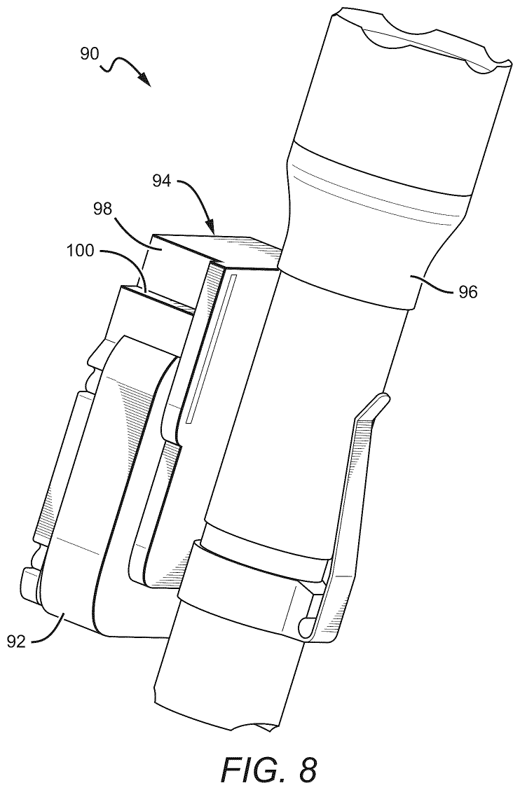

FIG. 8 shows another embodiment of a retractor system 90 according to the present invention comprising a retractor 92, and an adaptor 94 mounted to a personal article 96. In this embodiment, the personal article comprises a flashlight and the adaptor 94 is mounted directly to the flashlight body using any of the methods, materials or devices described above. In this embodiment, the adaptor 94 comprises and extension 98 that rests on the top surface 100 of the retractor 92. The extension 98 can comprise one or more magnets or can be provided without magnets. Similarly, the top surface 100 can be provided with or without magnets.

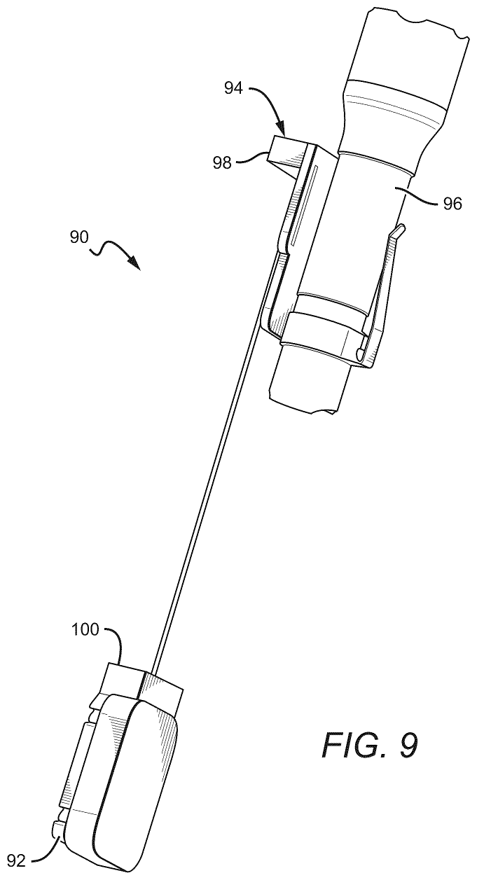

FIG. 9 shows the retractor system 90 with the personal article 96 separated from the retractor 92 under a pulling or separation force. This causes extension of the extendable line against the retraction force of the retractor's internal spring. With removal of the pulling or separation force, the personal article returns to location as shown in FIG. 8, with the extension 98 resting on the top surface 100. In the embodiment shown, the extension 98 and top surface 100 comprise one or more magnets to provide a reliable holding force for the personal article 96 to the retractor 92. In other embodiment, the retractor system 90 can be provided without magnets.

It is understood that many different mechanisms and arrangements can be used in the different systems according to the present invention. For example, when the extension portion or the retractor is made fully or partially of metal materials, then magnets may not be needed. The magnetic attraction between the metal and the magnets can be sufficient to securely hold the personal article to the retractor. It is also understood than many different personal articles can be used beyond cell phones, such as bar code readers, flashlights, box cutters, aerosol spray cans, etc. Although the present invention has been described in detail with reference to certain configurations thereof, versions are possible. Therefore, the spirit and scope of the invention should not be limited to the versions described above.

We claim:

1. A retractor system, comprising:
a retractor having a mounting mechanism for mounting to a user, said retractor comprising a housing with a top surface, an internal spring, and a line capable of extending from said housing through said top surface, said spring urging retraction of said line back in said housing; and
an adaptor integral to or mounted to a personal article, said adaptor having an extension portion extending away from said personal article, wherein said line is attached to said adaptor or personal article such that when said line is retracted into said retractor, said extension portion is on said retractor top surface.

2. The retractor system of claim 1, wherein said extension portion comprises a tab.

3. The retractor system of claim 1, wherein said extension portion comprises a support.

4. The retractor system of claim 1, further comprising one or more magnets to provide a magnetic force between said extension portion and said retractor housing.

5. The retractor system of claim 1, further comprising a first magnet integral to said extension portion and a second magnet integral to said retractor housing.

6. The retractor system of claim 1, further comprising anti-swing magnets.

7. The retractor system of claim 1, wherein said adaptor has an adaptor side surface and said retractor has a retractor housing side surface, wherein one or more magnets are arranged on said adaptor and retractor housing side surfaces.

8. The retractor system of claim 7, wherein said one or more magnets provide a magnetic force between said adaptor side surface and said retractor housing side surface.

9. A retractor system, comprising:
a retractor having a mounting mechanism for mounting to a user, said retractor comprising a housing with a top surface, an internal spring, and a line capable of extending from said housing through said top surface, said internal spring urging retraction of said line back in said housing;
an adaptor integral to or mounted to a personal article, said adaptor having an extension portion extending away from said personal article, wherein said line is attached to said adaptor or personal article such that when said line is retracted into said retractor, said extension portion is on said top surface; and
first and second magnets wherein said first magnet is integral to said extension portion and said second magnet is integral to said retractor housing to provide a magnetic force between said extension portion and said housing.

10. The retractor system of claim 9, further comprising anti-swing magnets.

11. The retractor system of claim 9, wherein said anti-swing magnets reduce swinging of said personal article relative to said retractor.

12. The retractor system of claim 9, wherein said adaptor has an adaptor side surface and said retractor has a retractor housing side surface, wherein third and fourth magnets are arranged on said adaptor and retractor housing side surfaces.

13. The retractor system of claim 12, wherein said third and fourth magnets provide a magnetic force between said adaptor side surface and said retractor housing side surface.

14. A retractor system, comprising:
a retractor having a mounting mechanism for mounting to a user, said retractor comprising a retractor housing with a top surface, an internal spring, and a line capable of extending from said housing through said top surface, said spring urging retraction of said line back in said housing;
an extension portion integral a personal article, and extending away from said personal article, wherein said line is attached to said extension portion or personal article such that when said line is retracted into said retractor said extension portion is on said retractor top surface; and
one or more magnets on said extension portion, personal article or said retractor housing to provide a holding force between said personal article and said retractor.

15. The retractor system of claim 14, wherein said extension portion comprises a tab or a support.

16. The retractor system of claim 14, wherein said one or more magnets comprises a first magnet integral to said extension portion and a second magnet integral to said retractor housing.

17. The retractor system of claim 14, wherein said one or more magnets comprise anti-swing magnets.

18. The retractor system of claim 14, wherein said adaptor has an adaptor side surface and said retractor has a retractor housing side surface, wherein as least some of said one or more magnets are arranged on said adaptor and retractor housing side surfaces.

19. The retractor system of claim 18, wherein said at least some of said one or more magnets provide a magnetic force between said adaptor side surface and said retractor housing side surface.

20. The retractor system of 14, wherein said personal article comprises a cell phone.
